(19) United States
(12) Patent Application Publication
(10) Pub. No.: US 2011/0020777 A1
(43) Pub. Date: Jan. 27, 2011

(54) JURY RESEARCH SYSTEM

(75) Inventor: William Kent Hughes, Austin, TX (US)

Correspondence Address: BAKER & MCKENZIE LLP, Pennzoil Place, South Tower, 711 Louisiana, Suite 3400, Houston, TX, 77002, US

(73) Assignee: TRIALSMITH INC., Austin, TX (US)

(21) Appl. No.: 12/769,184

(22) Filed: Apr. 28, 2010

Related U.S. Application Data
(60) Provisional application No. 61/173,361, filed on Apr. 28, 2009.

(51) Int. Cl. G09B 19/00

(52) U.S. Cl. 434/235

(57) ABSTRACT

A system for obtaining information on individuals including jurors and providing a variety of reports via the Internet in a rapid manner. The reports can be compiled and reviewed simultaneously by multiple users and notes can be included on the report format. The user may customize the information searched and presented.

### PRIOR RELATED APPLICATIONS

This Non-Provisional application claims the benefit of U.S. Provisional Application No. 60/173,361, filed Apr. 28, 2009 which is hereby incorporated by reference in its entirety.

### FEDERALLY SPONSORED RESEARCH STATEMENT

Not applicable.

### REFERENCE TO MICROFICHE APPENDIX

Not applicable.

### FIELD OF THE INVENTION

The Field of the Invention relates to using and searching publicly accessible and other available databases to review quickly information on individuals via the Internet. Reports of relevant information are prepared in a form that can be sent via the Internet. The field can be for any type of search where individuals information is relevant such as jury research and selection.

### BACKGROUND OF THE INVENTION

Rapid gathering and review of personal information is often necessary in processes including jury selection. There are multiple databases that vary from state to state and county to county inside each state. In addition, there are national databases fro credit information and the like that are helpful in making an evaluation of a suitable juror. However, often the list of jurors is not available long in advance of a trial and the lawyers making the selection, have little information that the routinely provided by the juror during the selection process. The lawyers typically have a limited time to question the jurors to obtain important information needed for the jury selection process.

Technology that can quickly access information on each juror for a variety of sources and process the information relevant for the selection process would be beneficial for the lawyer at the beginning of a jury trial. This technology would also be helpful for job candidate screening and other instances when quick information on an individual is desired.

### SUMMARY OF THE INVENTION

The invention relates to a system and invention for rapidly processing a list of jurors who have been chosen to serve on a jury and producing a detailed report and summary of background report for each juror. Although the system is for analysis of juror information, it can be used for any process to obtain data on individuals in a rapid manner.

The system for analyzing data on individuals by inputting the name of at least one individual in a query to the internet through a web browser from at least one device that can access the internet. The user then accesses data from at least one designated location in the internet or other databases accesses by other methods by matching the name inputted to data on individuals in the designated locations. The matches are compiled in a list are then transmitted to at least one device such that a user can select a match from the list for one of the names that was sent. The matching process is conducted with simultaneous searching of the internet locations with multiple computers via cloud computing for data on the various individuals. The system also parses the data found on at least one location on the internet on at least one individual as desired by the user and a detailed report is prepared. The report is sent to at least one user through the internet.

The names of the individuals searched may also be sent to a list serve or similar list for review by the recipients of the list serve and the detailed report may also be reviewed. The user may also add questions or noted to the reports and report results.

### BRIEF DESCRIPTION OF THE DRAWINGS

FIG. 1 is an example of the case listing utilizing the jury research system.

FIGS. 2, 3 and 4 are an example of the case information and juror parameters used by the invention.

FIG. 5 is a sample Juror Identification Data (“ID”) Report.

FIG. 6 is a Juror Number Assignment Form.

FIG. 7 is an example of the Field Edits of Jurors.

FIGS. 8 and 9 are samples of the Detailed Report.

FIG. 10 is a sample of the Juror Renumbering Tool.

FIG. 11 is a sample of the Juror Filtering Feature.

FIG. 12 is the a sample of the ask a Colleague Feature.

FIG. 13 is a sample of the custom fields export information.

FIG. 14 is a Juror Card with Custom Fields.

FIG. 15 is a sample of the juror information with notes.

FIG. 16 is a schematic of the Jury Research System.

### DETAILED DESCRIPTION OF THE INVENTION

The following is a description of a Jury Research System. This system can be used by lawyers and those working with lawyers to quickly assess (preferably in less than 30 minutes) a complete profile on each prospective juror in a case. With this additional information, the lawyer has more data on each juror to assist in questioning (voir dire) and selecting jurors.

A system for retrieving, organizing and storing juror information from disparate sources, and databases so that consultants, paralegals and lawyers can review information on jurors in a single online system. The jury research system aggregates data from many sources including but not limited to publicly available databases. The sources can be unlimited and can be integrated into the jury system's API. The jury system allows for unique data to be automatically gathered based on the state of residence or former residence of the juror. Some states have different data, databases, Web sites and other sources which may be unique to that state.

The jury research system streamlines the process of organizing and storing the information from disparate sources. Data is stored in a uniform format that is easily analyzed and annotated by the lawyer. The system is a web-based access service. The jury research system will be accessible through the World Wide Web using the existing technology to access the Internet. The Internet is used to access the system. The jury research system will be compatible with all major Internet Web browsers and compatible on both Macintosh and PC computers and other devices. The jury research system will be accessible through mobile devices (phones and PDAs).

In the preferred mode, software is needed for end-users to utilize the jury research system. The access to the jury research system can be through Secure Sockets Layer (SSL) Connections or other secure settings or methods, if desired. No database is built or maintained to manage the jury research data Web-based access will allow the lawyer, paralegals and jury consultants to have simultaneous and remote access during voir dire and pre-trial. Any user can be designated and in this specification if the term lawyer used to describe a feature it is understood that any other designated user such as a paralegal or consultant can perform the same function and/or task.

The jury research system uses Interface features to enhance usability and speed of operation. AJAX or a similar program will be used to update fields, tags and other toggles in the user interface thereby reducing Web page reloads and increasing speed of use by end-users. The purpose of an AJAX type program is to make it easier for lawyers to make notes and interact with the data without having to reload the entire Web pages each time an item is flagged, updated or changed by other users.

Fields are also updated automatically without reloading Web pages. This ensures that lawyers can see changes made to juror profiles by other lawyers and paralegals within the system without having to reload their Web browser. For example, if a check box is clicked on the Web page to indicate the juror is “dismissed,” simply clicking the check box will automatically update the database without having to click a save button on the Web page and without having to reload the page.

Remote users will automatically see changes made by other lawyers typically within 1 minute without having to reload their Web pages. AJAX type programs will allow data updates to occur with less data being transmitted. This makes it easier to interact with the jury research system over low-speed Internet connections or other wireless devices likes phones and PDAs.

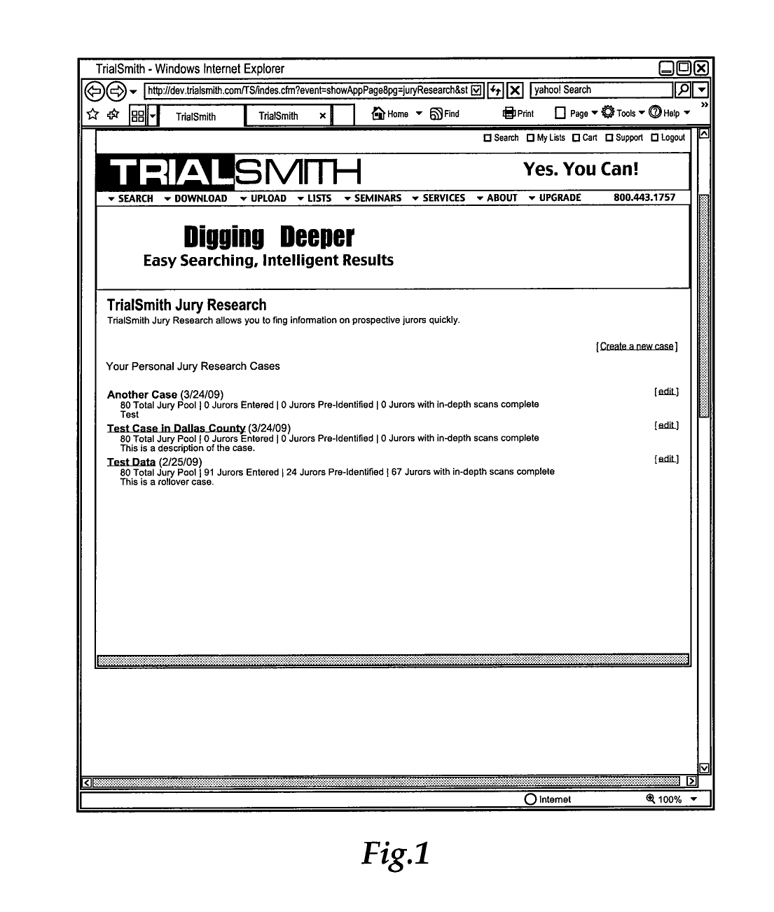

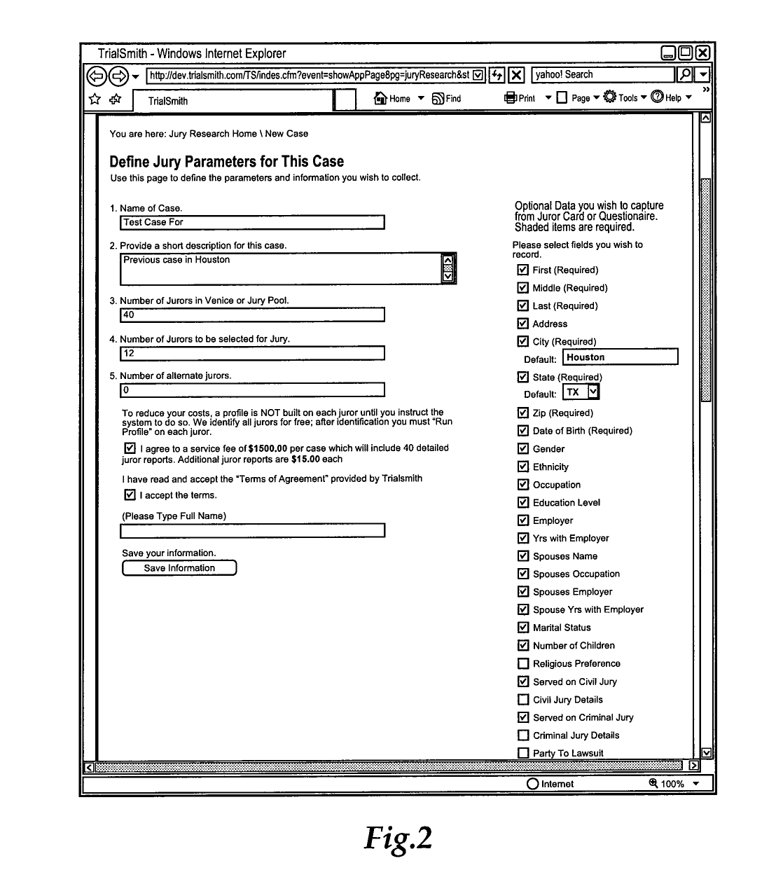

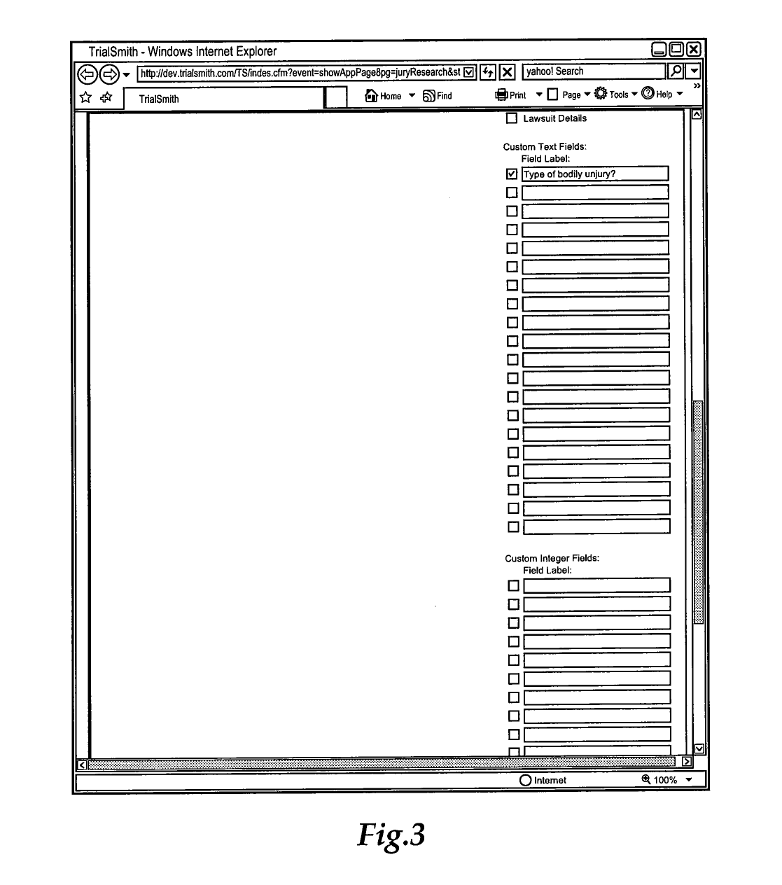

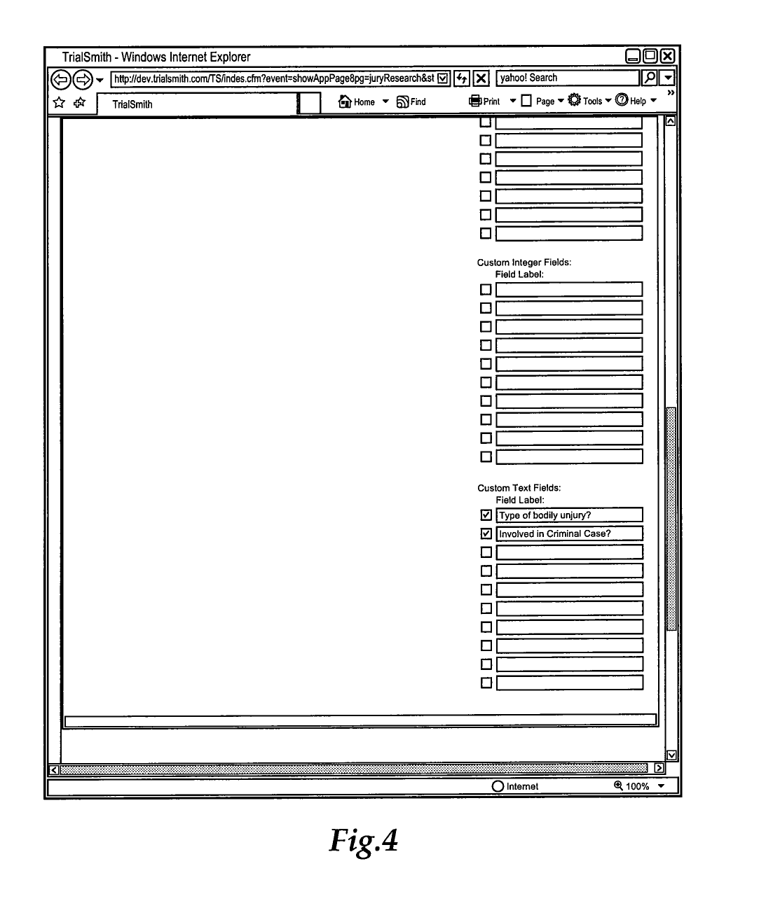

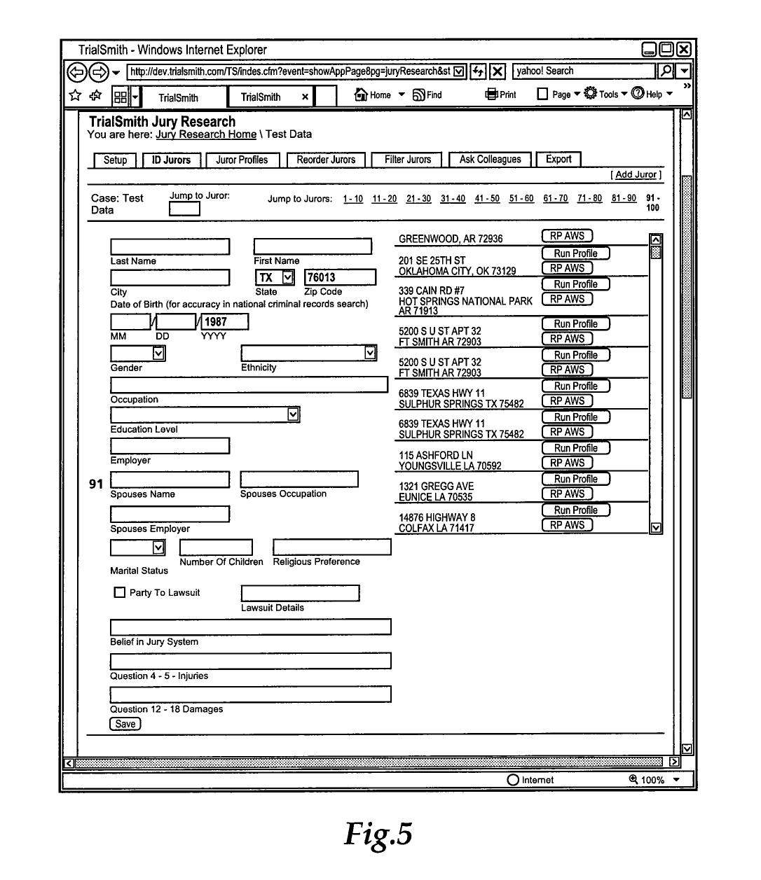

The jury research system is capable of management of multiple cases. The system supports multiple cases which can be defined by the lawyer. Cases can be activated and managed simultaneously. Upon accessing the system, the lawyer must select a case (See FIG. 1) or define a specific case as shown in FIGS. 2, 3 and 4, which are a table with parameters for the number of jurors in the jury pool, the number or jurors to be selected in the case, the personal data that the lawyers wants to search including information not provided on the prospective jurors by the court.

Once a case is selected during a user session, all subsequent screens and juror data will be related to the selected or defined case. Cases can be referenced in the future or deleted. The system is completely Web-based. Internet access and Web browser are required to use the system. The juror research system allows multiple lawyers, investigators, jury consultants and paralegals to access the juror data simultaneously from different locations. Simultaneously, all users in the jury system working on the specific case will see updates for the juror when they are updated by other users. AJAX tasks each client's Web session to go out and poll the database for each juror's current data periodically.

The value is that multiple individuals can help to identify jurors in 15-30 minutes. Time is of the essence in many trials where the juror list is presented to the lawyer an hour or less before the trial. In addition, screens are updated as changes are made on jurors. Prospective jurors are identified so that that detailed juror profiles reports and background reports can be processed. To facilitate and speed the process of identification, jurors can be identified through several different processes:

In one embodiment of the system Identification Method 1 is used to request data by initially identifying jurors in public records and voter records by querying each juror name. (See FIG. 5) Only the juror's first and last name, and city are required to perform an initial “ID Search” to help the lawyer save time in processing the list of prospective jurors. Multiple juror ID searches can be performed at a time either by multiple end-users, or by a single users who is entering multiple names simultaneously.

The ID Search then can go to a to a third-party database and searches credit headers for matches on the person's name. If a match is not found in the city, the search is expanded within the juror's state. Likely Juror ID matches are displayed typically within 1-3 seconds. Matches contain the juror's name as appearing in credit headers and other records, including the juror's complete address and year of birth.

The lawyer selects the correct Juror and clicks a button to “Run Profile.” A Detailed Report is prepared in the background for the juror allowing the end-users to continue analyzing other jurors while the juror reports are processed. The Detailed Report may take around 120 seconds to complete

Juror Detailed Report searches are performed in “cloud computing.” This allows an unlimited number of servers to be activated to process queries, collect data in XML or other preferred (XML is used herein as a preferred embodiment) format, extract data from the xml, parse out data desired for storage in the juror's record, convert data to new XML format, queue data in “cloud” for transmission to Juror database at the systems operation center, data transferred via XML and placed in the juror's record, and finally the lawyer is notified through AJAX.

Since the Detailed Report may require 1-2 minutes to process, utilization of cloud computing allows the system to scale the number of necessary servers to run Detailed Report jobs without affecting CPUs, processing or other Web services provided to end-users. This increases speed, efficiency and overall system performance. The lawyer is immediately notified through the Web interface that the juror profile is complete. The user can view each juror's record separately online via the wireless device supporting WAP protocol.

Another embodiment of the present invention is shown in Identification Method 2 by initially identifying jurors in public records and voter records by submitting a juror list electronically via Email or Web Interface. Only the juror's first and last name, and city can be submitted in a text delimited format or via Excel or other preferred file for quick identification of the entire juror list. Juror names are automatically loaded to the jury system. Multiple juror ID initial searches are performed at a time either by “cloud” computing. or other methods. The ID Search then goes to a third-party database and searches credit headers for matches on the person's name. If a match is not found in the city, the search is expanded within the juror's state. This step is performed simultaneously for all records.

Likely juror ID matches are displayed within about 10 seconds for all juror names uploaded via Text, Excel or other similar program. Matches contain the juror's name as appearing in credit headers and other records, including the juror's complete address and year of birth. The user scrolls through the list of prospective jurors and selects the correct Juror and clicks a “Run Profile” button. A Detailed Report is prepared in the background for the juror allowing the end-users to continue analyzing other jurors while the juror reports are processed. The Detailed Report may take about 120 seconds to complete for each juror, and reports can be prepared simultaneously.

Searches on the prospective jurors to prepare the Detailed Report are performed in “cloud computing.” This allows an unlimited number of servers to be activated to process queries, collect data in xml format, extract data from the xml, parse out data desired for storage in the juror's record, convert data to new XML format, queue data in “cloud” for transmission to Juror database at the systems operation center, data transferred via XML and placed in the juror's record, and finally the lawyer is notified through AJAX.

Since the Detailed Report may require about 1-2 minutes to process, utilization of cloud computing allows the system to scale the number of necessary servers to run Detailed Report jobs without affecting CPUs, processing or other Web services provided to end-users. This increases speed, efficiency and overall system performance. The user is immediately notified through the Web interface that the juror profile is complete. The user can view each juror's record separately online via the wireless device supporting WAP protocol.

Another embodiment of the present invention is shown in Identification Method 3 which is initially identifying a single juror in public records and voter records by submitting a juror Name and Zip Code from a Cell Phone, PDA or electronic device. Only the juror's first and last name, and city are required to perform an initial “ID Search” to help the lawyer save time. The initial search can be performed from a wireless PDA, Cell phone or other wireless data device with internet access. The interface for the mobile device supports a single search at a time, and allows for a single juror's record to be viewed online at one time. The interface is developed using “WAP” —Wireless Access Protocol which uses less bandwidth and allows for faster data transmission.
a. An initial ID search is performed on the juror name. The ID Search goes to the Merlin Information Systems or other similar system and searches credit headers for matches on the person's name. If a match is not found in the city, the search is expanded within the juror's state. The ID matches are displayed within about 1-3 seconds. Matches contain the juror's name as appearing in credit headers and other records, and the juror's address. The lawyer selects the correct Juror from the list of possible matches. By simply clicking the “Run Profile” button the Detailed Report is prepared in the background on the juror. This Detailed Report may take about 120 seconds to complete. Since the Detailed Report takes about 1-2 minutes to process, different servers are used to queue up Detailed Report jobs, and those jobs are processed by those servers. This eliminates performance issues with the Web interface to the jury system.

Once the Detailed Report is complete, the data is then transmitted back to the primary database record for each juror, and the lawyer is immediately notified through the Web interface that the search is complete. The user can view each juror's record separately online via the wireless device supporting WAP protocol. This service is ideal if a single juror needs to be researched, but the entire juror list is not needed.

Another embodiment of the present invention is shown in Identification Method 4 by identifying a single juror in public records and voter records by submitting a juror Drivers License Number, Social Security Number or other personal identifying number found in records available to the public over the Internet or other sources. Only the Juror's drivers license number, social security number or other personally identifying information is needed to perform a search of a juror. Only the single piece of information is needed to perform the background check on a specific juror. The interface is developed using “WAP”—Wireless Access Protocol which uses less bandwidth and allows for faster data transmission. The juror's detailed background report is automatically processed because the juror has already been positively identified.

Since the Detailed Report needs to be completed as soon as possible and preferably in about 1-2 minutes, different servers are used to queue up Detailed Report jobs for searches of various sources of information for numerous jurors, and those jobs are processed simultaneously by multiple servers. This processing is superior to Web searching each source of information one by one on separate websites or databases. Once the Detailed Report is complete, the data is then transmitted back to the Systems Operations Center's primary database record for each juror, and the lawyer is immediately notified through the Web interface that the search is complete. The user can view each juror's record separately online via the wireless device supporting WAP protocol. This service is ideal if a single juror needs to be researched, but the entire juror list is not needed.

Another embodiment of the present invention is shown in Identification Method 5 by identifying all jurors in public records and voter records by submitting a series of Drivers License Numbers, Social Security Numbers or other personal identifying numbers commonly found in public records. Only the Juror's drivers license number of social security number or other personally identifying information is needed to perform a search of a juror. The user uploads a list of drivers license numbers or other personally identifying number to the jury research system. Background searches are performed all persons identified in the list of personally identifying numbers. The list may be uploaded by Excel, Text Delimited, or by input manually via a Web interface.

The jurors do not need to be identified because the juror has already been positively identified through their personal ID. Since the Detailed Report takes about 1-2 minutes to process, different servers are used to queue up Detailed Report jobs, and those jobs are processed by those servers as described previously. Once the Detailed Report is complete, the data is then transmitted back to the primary database record for each juror, and the lawyer is immediately notified through the Web interface that the search is complete. The user can view each juror's record separately online via the wireless device supporting WAP protocol.

Another embodiment of the present invention is the system for fuzzy searching of juror names to facilitate and speed the process of identification of jurors, jurors' spouses and their neighbors without having a drivers license number of a social security number. Fuzzy search uses minimal information for fast processing: During the initial ID search described above, the lawyer or paralegal is only required to enter the juror's first name, last name and city to begin a search. (See FIG. 5)

In another embodiment there is an expand fuzzy search during the ID phase described above, the user is only required to enter the juror's first name, last name and city to begin a search, however, the juror's full address including zip code can also be entered. The fuzzy search utilizes a unique system that scans a national database of credit headers to identify prospective jurors. By using credit headers, the juror is more accurately identified.

The fuzzy search also provides the lawyer with not only the Juror's credit header and address, but all other addresses that juror has been associated with in their credit history. The fuzzy search may also provide the juror's spouse and other people living with the juror. Utilizing credit headers and credit history, the lawyer can quickly and accurately locate jurors and their spouses. The credit header database is also much larger and accurate than most other databases of citizen records. If the juror is not identified within the City and Zip Code when the fuzzy search is performed, the system automatically scans for the juror in a statewide database of credit headers. This facilitates identification even if the juror has recently moved within the state or a metropolitan area. Once identified (selecting the right juror in credit headers who matches the actual juror), the in-depth query can be performed with a single click.

In another embodiment there is a system of assigning juror numbers to prospective jurors.

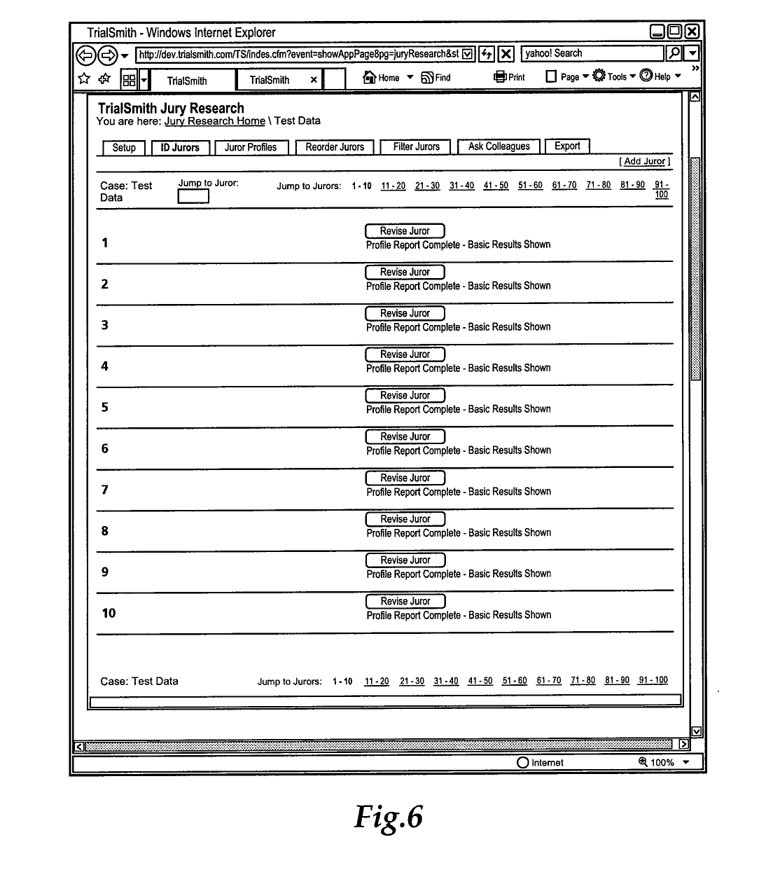

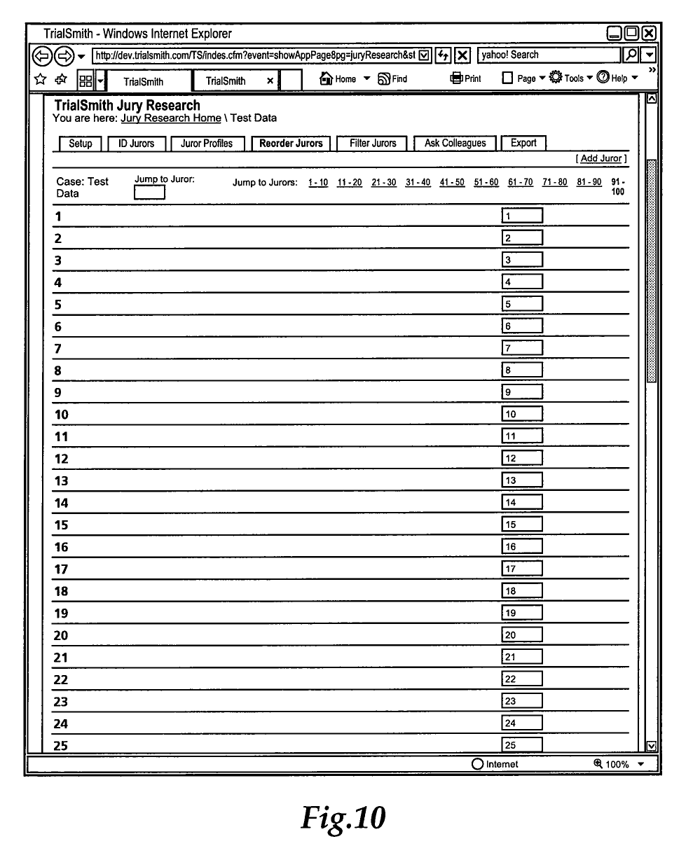

Each juror can be assigned a juror number in when entered in the system or other alpha numeric descriptions can be used. (See FIG. 6) The juror number is commonly used in courts and can be the assigned number for ease in identification. The juror number can be changed at any time by the user. Jurors can also be re-numbered with a special juror renumbering tool. (See FIG. 10)

In another embodiment there is a addition of custom fields and specialized Data. Each case can be customized to accommodate any number of custom fields. (See FIGS. 2, 3 and 4) Custom fields are created for each juror and stored with the juror's profile for the specific case. Custom fields are used to collect additional information on each juror that is included on the juror card, or additional information that may be obtained from a juror questionnaire or through the voir dire process. For example, you may want to know if the juror has ever worked for a railroad. That separate piece of data can be captured in a true/false type of question or in an open text format.

Standard fields and formats are pre-defined for each juror, and those fields can be activated or disabled based on needs for the case. The user can also create other custom fields based on specific parameters of their case. For example, if the lawyer wishes to ask a specific question about the status of the employee' health insurance, they could ask that question on a jury questionnaire or verbally during voir dire. The jury research system allows the lawyer to define a specific question for health insurance in this juror research project, and record data/results within those fields.

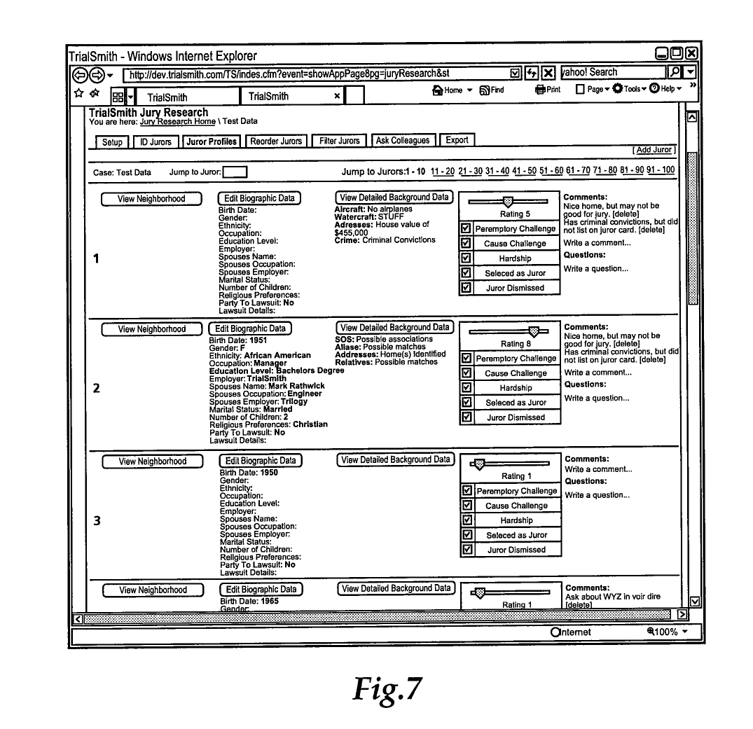

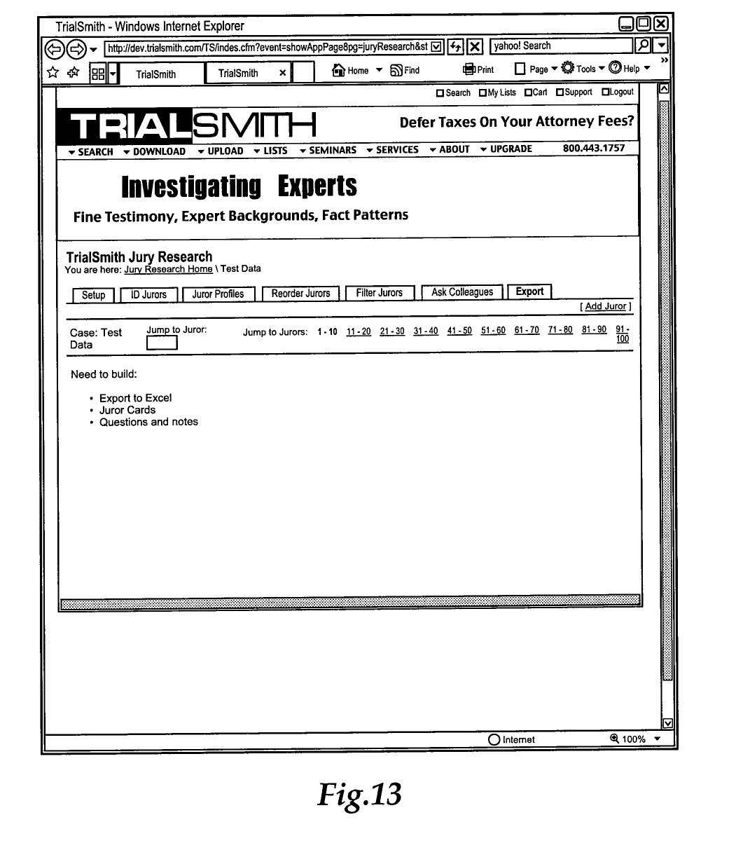

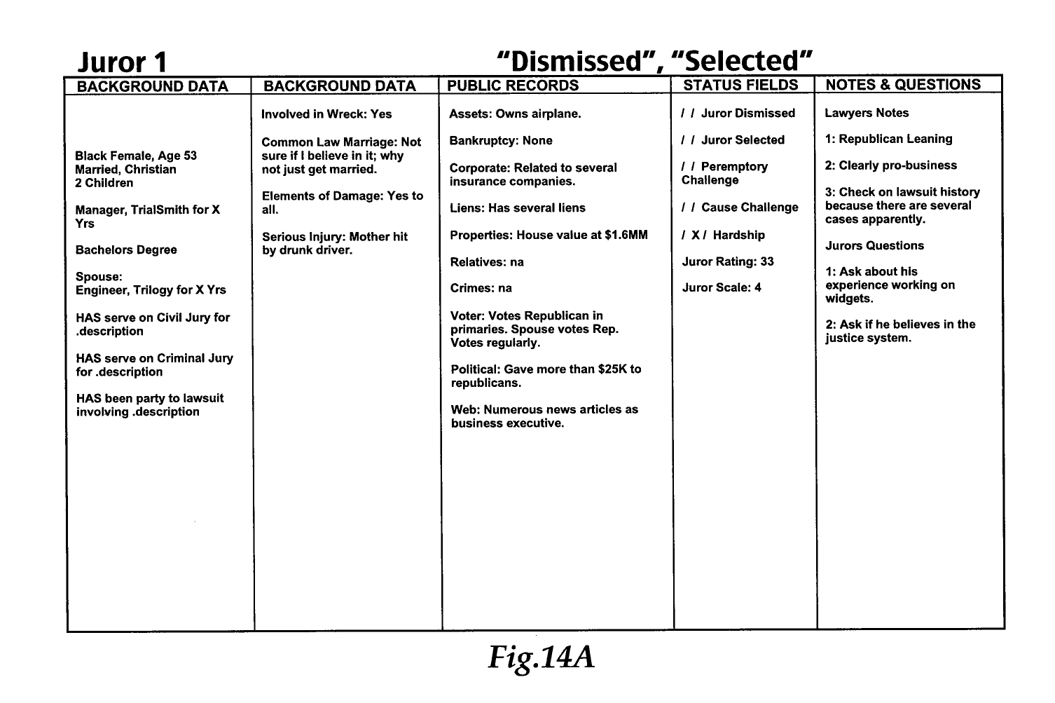

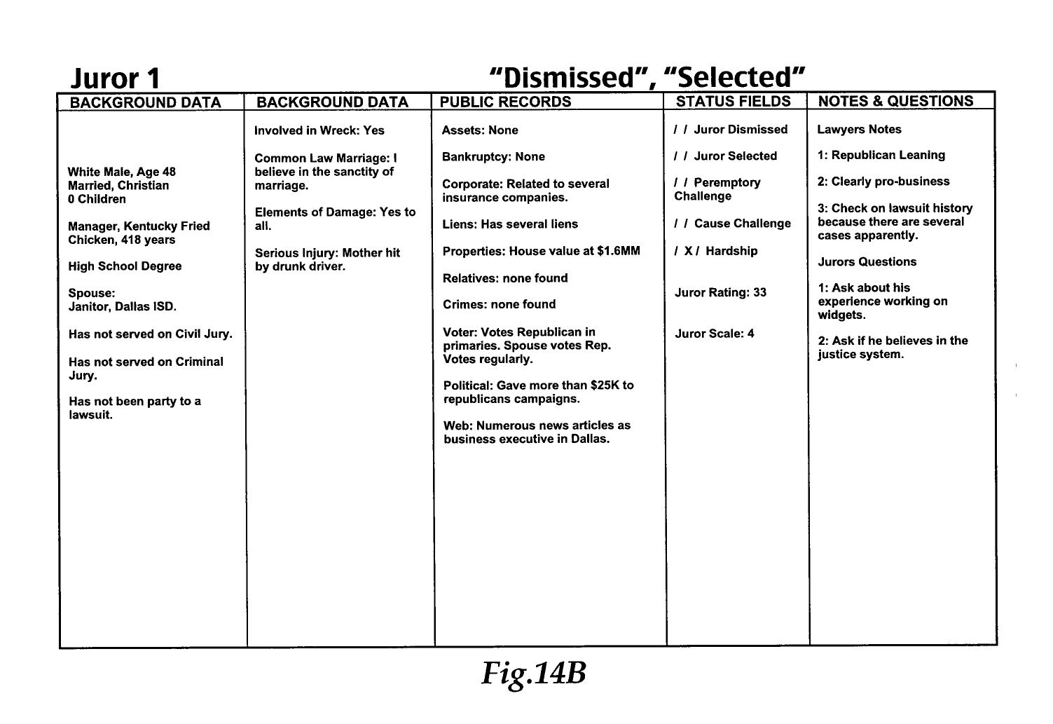

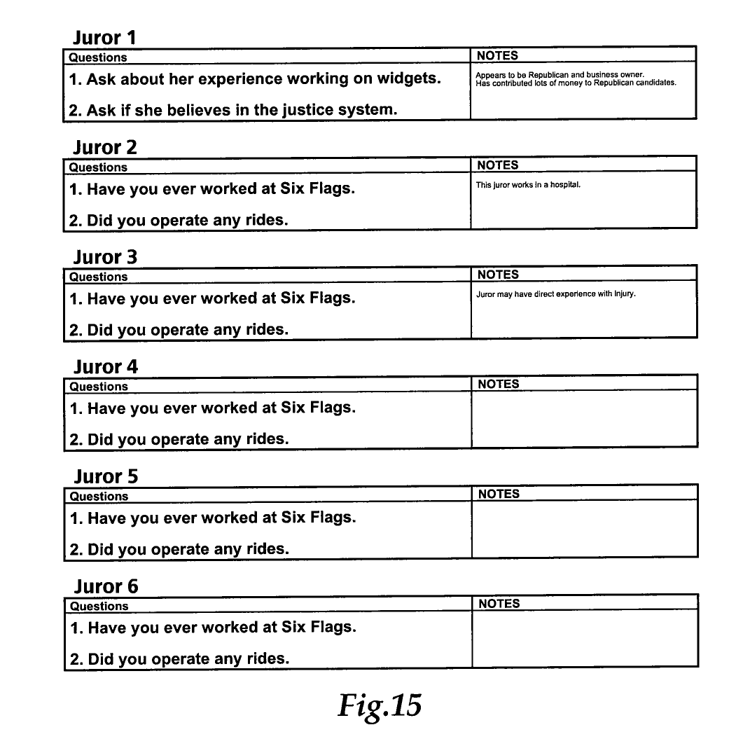

Custom fields can be displayed on the juror card, and the lawyer can determine which of those fields should print on the card. (See FIG. 14) Custom fields can be exported into Excel for analysis or for create or other reports. (See FIG. 13) Custom fields and the data contained within the custom fields can be edited at any time within the jury research system. For example, if a juror made a comment about a specific questions, the lawyer could click that juror's record and quickly click edit. (See FIG. 7)

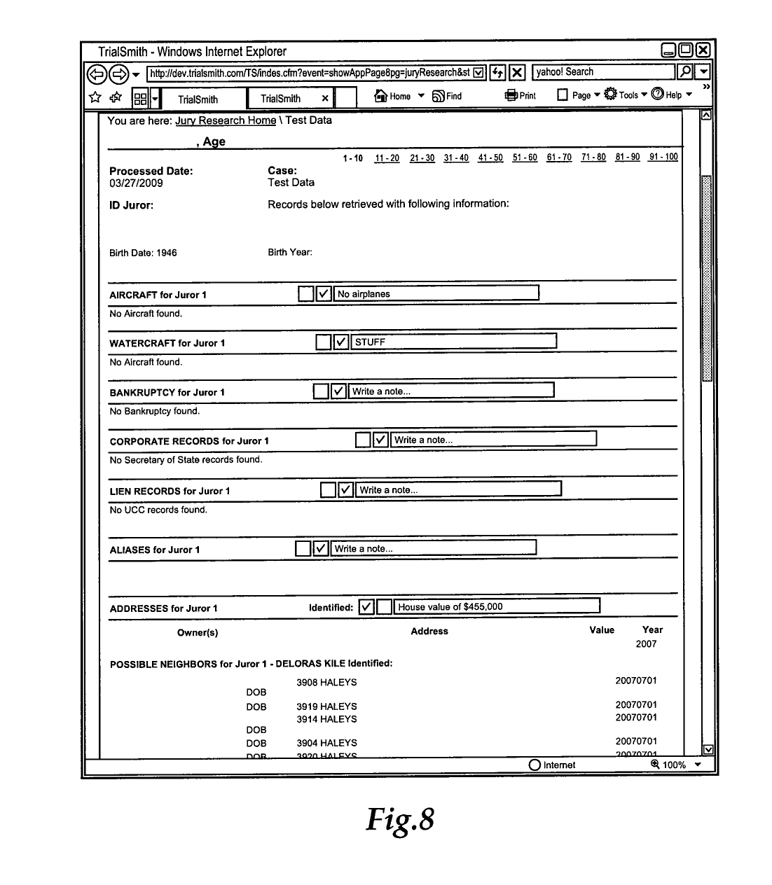

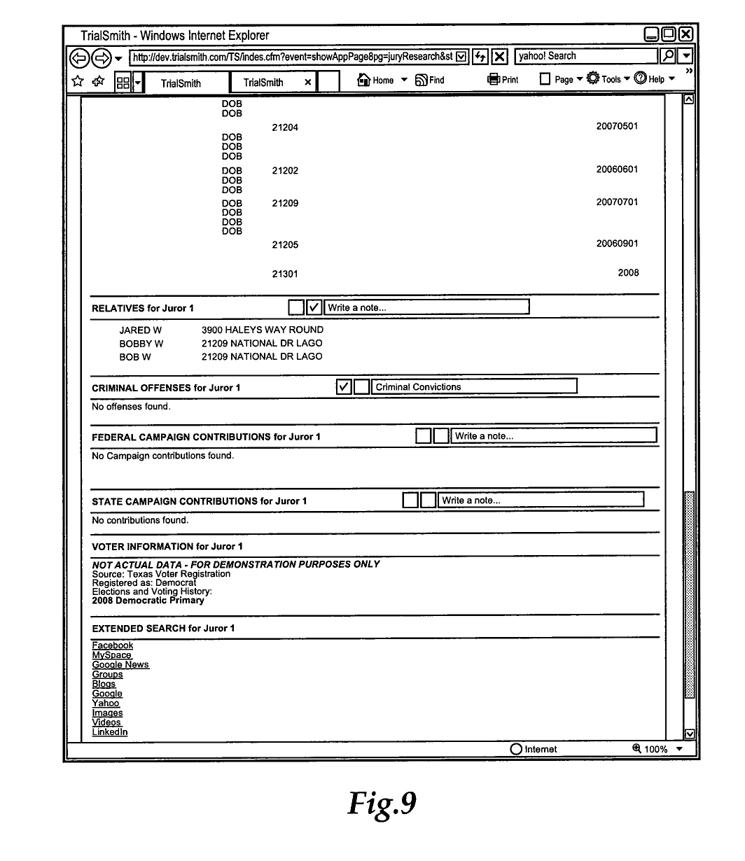

In another embodiment a Detailed Report is created once the juror has been identified. The system is instructed by the user to perform a Detailed Report on each juror. (See FIGS. 8 and 9) The number of databases and third-party databases which can be searched are not limited to the following finite list of public record databases. However, the following list illustrates the types of potential databases and personal information that can be collected for the Detailed Juror Report.

Search Engines and Social Media Sites: Automatic Creation of unique URLS for each juror is embedded with search terms in Detailed Juror Report and a Comprehensive Search an be performed as follows:

A comprehensive list of Web sites, social media sites and other resources are provided in a list in each Jurors' Detailed Report. There is no limit to the number of possible Web sites which could be searched.

The user can save time by simply clicking on any the Sites and having a search automatically performed on the juror. For example, clicking on “Google News” would launch a new window and display all news articles having the Juror's First and Last Name in the city where the juror resides.

The system will optimize how searches are performed to refine the number of matches in an attempt to limit results to each specific juror. Placing the juror's name in quotes, followed by their city mailing address is much more likely to identify and target information related to that specific juror. These optimization help lawyers more quickly view results from the Web without having to perform separate searches.

User can make notes about records found on social media Web sites and those notes are stored with each juror, simplifying the ability for the lawyer to summarize data that is found online.

Automatic calculation of the number of hits or search matches are attached to each Web site and Social Media site. During the Comprehensive Search performed automatically by the servers, each search engine and social media site is polled to calculate the number of possible search hits for each juror. The number of search hits for each juror are stored in each juror's Detailed Report. This saves the user time by identifying potential search engines and social media sites that should be studied for possible information about the juror. Lawyers can makes notes about hits found in order to provide an easy mechanism to summarize the information.

In another embodiment there is a general public records search. Third-party Web sites and databases can be used to perform various searches of public records on individuals. There are no limits to the number of databases which could be queried from third-party sources once identified. The system may employ duplicate databases from multiple sources to ensure the broadest collection of information relevant to each juror. Lawyers can makes notes about the public records found in order to provide an easy mechanism to summarize the information.

In another embodiment there is voter records are searched. Third-party Web sites or internal databases, can be used to search for detailed voter history and voter information for each prospective juror. The search can include voter history and voter information for each prospective juror's spouse, significant others, family members or other individuals living with the juror. The search can identify whether the voter is Democrat or Republican and can identify elections the voter has participated in, and identify voter behavior and profiles. The search can identify the overall voting behavior in the juror's city, precinct and zip code.

Lawyers can makes notes about the voter records found in order to provide an easy mechanism to summarize the information.

In another embodiment there is Federal Campaign Contributions can be tracked. The Federal Election Commission or other third-party Web sits, can be used to scan for each juror's federal campaign contributions. The value of contributions and to which campaigns the juror made a contribution can be reviewed and reported. Lawyers can makes notes about the campaign contributions found in order to provide an easy mechanism to summarize the information.

In another embodiment criminal offenses can be revealed. Third-party databases can be used to search each juror's record for state and federal criminal convictions and deferred adjudication. Records will be national in scope. Lawyers can makes notes about the criminal offenses found in order to provide an easy mechanism to summarize the information.

In another embodiment professional disciplinary actions can be revealed. Professional disciplinary actions in the juror's state can be searched to determine if the juror has ever been sanctioned professionally for any violations. These may be in the medical field, and all other professional licensed fields of practice. Records will be national in scope. Lawyers can makes notes about disciplinary actions found in order to provide an easy mechanism to summarize the information.

In another embodiment expert witness activity can be tracked. Each juror name can be searched against Expert Names databases to determine if the juror has ever testified as an expert in a case. Records will be national in scope and may include various sources including Expert services Web sites. Lawyers can makes notes about expert information found in order to provide an easy mechanism to summarize the information.

In another embodiment judgments involving prospective jurors can be reviewed. Prior lawsuits and judgments are searched for matches for each juror name. Records will be national in scope. Lawyers can makes notes about judgments found in order to provide an easy mechanism to summarize the information.

In another embodiment information on the relatives of a Juror can be reviewed. A list of possible relatives will be identified for each juror using the same tools. The relatives can include name, address and phone number of relative. The search can be national in scope. Lawyers can makes notes about relatives found in order to provide an easy mechanism to summarize the information.

In another embodiment property owned and the addresses of a juror can be reviewed. A list of all possible properties and addresses can be identified for each juror. The scope will be national. Homes, if found, will contain home values based on tax records. Lawyers can makes notes about property and addresses found in order to provide an easy mechanism to summarize the information.

In another embodiment possible neighbors can be located. A list of possible neighbors is identified for each juror. The list of neighbors can include the neighbor's names, year of birth, address, telephone number and any other publicly available information. Lawyers can makes notes about neighbors found in order to provide an easy mechanism to summarize the information.

In another embodiment a list of possible alias for each juror can be produced based on the juror's social security number linked to names other than the juror. The search can be national in scope. Lawyers can makes notes about aliases found in order to provide an easy mechanism to summarize the information.

In another embodiment liens for a juror can be loaded. A list of possible Liens can be produced for each juror. Liens including the state, county, type of lien, date, including names and details of the liens found. The search will be national in scope. Lawyers can makes notes about liens found in order to provide an easy mechanism to summarize the information.

In another embodiment corporate records are revealed. A list of possible corporations associated with juror can be identified. Corporations can include the state, corporation name, status of charter, type of corporation, year incorporated, including DBA name, charter number, and officers, directors. The search will be national in scope. Lawyers can makes notes about corporate records found in order to provide an easy mechanism to summarize the information.

In another embodiment bankruptcies can be located. Each juror's name scans all bankruptcy records to identify potential bankruptcies. The search is national in scope. Lawyers can makes notes about bankruptcies found in order to provide an easy mechanism to summarize the information.

In another embodiment the ownership of watercraft, aircraft and/or motor vehicles can be added to the report on a juror. Each juror's name scans all records for possible ownership. The search is national in scope. Lawyers can makes notes about watercraft found in order to provide an easy mechanism to summarize the information.

In another embodiment, drivers license records may be searched. Each juror's name can be scanned for all drivers license records for possible matches. The search is national in scope. Lawyers can makes notes about drivers license records found in order to provide an easy mechanism to summarize the information.

In another embodiment an author and blog search can be made. Journals, blogs and publications can be searched to determine if the juror has authored articles. The search is international in scope and multiple databases are utilized. Lawyers can makes notes about author records found in order to provide an easy mechanism to summarize the information.

In another embodiment state campaign contributions can be reviewed. Using state ethics commission and other state databases, political contribution history for jurors can be viewed. The information will include the amount of the juror's contributions and the candidates who were given contributions by the juror. Lawyers can makes notes about the campaign contributions found in order to provide an easy mechanism to summarize the information.

In another embodiment, utilizes maps and neighborhood cameras. A link is automatically provided from each juror's name to a street view on Google or other similar site. The view also gives the lawyer the option for the “street view,” thereby viewing the quality of homes, the type of neighborhood and other factors which may be relevant in the case.

In another embodiment magazine subscriptions are accessed. Juror name can be processed against magazine subscription database to identify interest or sociographic characteristics of potential jurors. The search is national in scope. Lawyers can makes notes about magazine subscriptions found in order to provide an easy mechanism to summarize the information.

Another embodiment includes an automated background assessment of the juror's spouse and family members. This features allows the lawyer to run a deeper scan of the juror's spouse to determine if any factors in the spouse's public record could affect the bias of the juror. When identifying jurors in the ID Process, lawyers have the option of simultaneously identifying the spouse or family members of the juror in question or any other persons living with the juror. Spouse and family members do not necessarily have to live with the juror, although their records are identified in the ID process. The ID process may also identify former spouses of the juror which can be analyzed. In the setup of each trial, the lawyer indicates if he prefers more thorough scans to be conducted on family members.

Lawyers can then ID other family members when they ID the juror, and those searches can be simultaneously performed utilizing all of the same background public records databases that are used for each juror. Public records found for spouses and family members are automatically assessed by the system so that the lawyer can quickly determine if the juror's family information have background information which may affect the bias of the juror.

Another embodiment is a automated background assessment of the juror's neighbors. This features allows the lawyer to run an thorough scan of the juror's neighbors at their residence to determine if any potential factors in the juror's could affect the bias of the juror. In the setup of each trial, the lawyer indicates if he prefers deep scans to be conducted on neighbors. Neighbor scans are performed after the initial in-depth scan is performed on the juror as an optional tool. If the juror warrants further investigation, the lawyer can click a button to have the system perform additional in-depth background checks on all neighbors. Public records found for neighbors are automatically assessed by the system and summarized so that the lawyer can determine information about any nearby neighbors which may be relevant to the juror.

Another embodiment is the automatic public records assessment from Detailed Report. This report is processed after the Detailed Report is processed, but before the lawyer previews the report. Although a Detailed Report is prepared automatically by the system for each juror, the data is summarized for the lawyer for fast inspection. (See FIG. 7)

At the time of processing each Detailed Report, if public records are found in any database or information source such as those listed in section X above, a short note is entered on each Juror's summary screen indicating to the lawyer that records have been found. For example, if a prospective juror had no public records found, the summary data would indicate nothing was found. Whereas if the juror had a prior bankruptcy, the user would be alerted with “Bankruptcy Found” in the overall profile report of the juror.

The automated summary data which is identified by the system and entered into the juror's profile report can be edited by the user when viewing detailed notes allowing complete flexibility. This automated assessment feature saves time by directing the user to focus attention on jurors who may have potentially relevant information in their public records.

In another embodiment there is a method for analyzing the Detailed Report for each juror. This provides a streamline system for analyzing all detailed background data that was retrieved in a public records search. Lawyers can open the full Detailed Report on each juror. (See FIGS. 8 and 9) The Detailed Report contains an aggregation of data organized by search area with results from all databases and searches. Data retrieved from third-party databases and internal databases are parsed for critical information which is then displayed in this summary report.

Each section of the report contains a NOTE area where comments can be entered by the lawyer. For example, in the Federal Election Commission section, the lawyer could study the data and type “Contributed more than 32K to Rep Campaigns.” The lawyer's notes roll up to the summary page on each juror making it easy to study the information at a glance. The lawyer can quickly navigate back to a specific juror's screen, or jump to a range of jurors by juror number. This Detailed Report can be printed for any juror. The Detailed Report contains links to a Detailed Report on the juror's spouse (if applicable) and Detailed Reports on the juror's neighbors (if applicable).

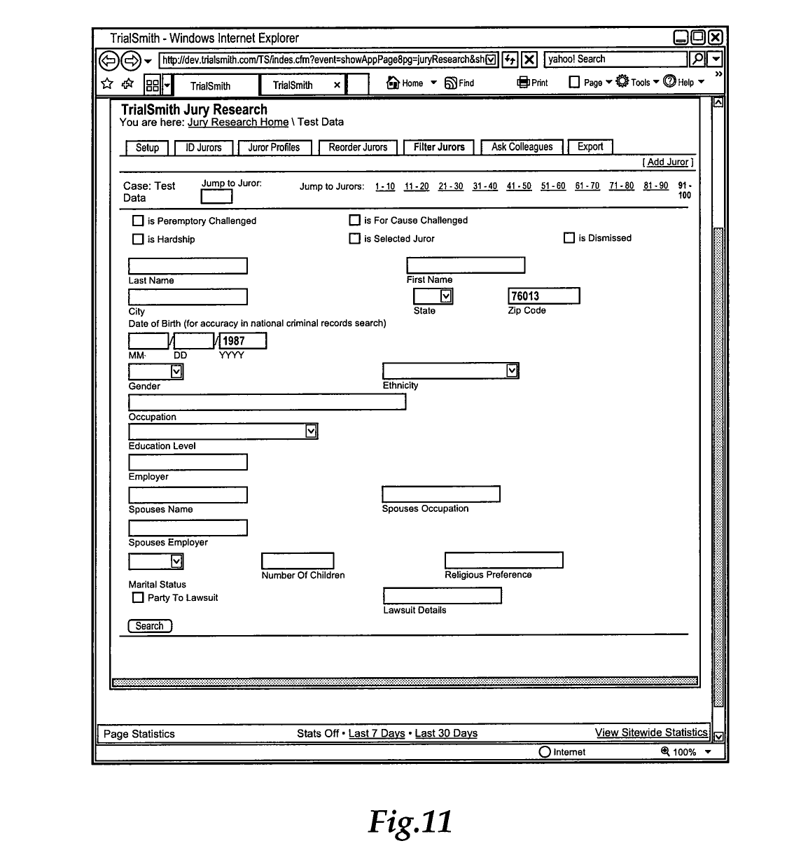

In another embodiment there is a juror filtering feature. The system provides a search of the jury pool for specific factors or information from the juror card, the juror's background data, or from other data input by the lawyer into the system. Lawyers can quickly produce a list of jurors based on any facts or background information that has been found for a juror. For example, a lawyer could ask to produce a list of jurors with or without a demographic, economic or other attribute and the list could be instantly produced. (See FIG. 11) Filtering produces results in the uniform juror screens that are used to manage the jury list making it easy to navigate the information and switch between juror records. The lawyer or those assisting can prepare a filter in advance or at the time of selection to identify juror attributes.

The system also provides for a method to reorder jurors—This is a simple system for the lawyer to instantly reassign juror numbers to a pre-existing list of jurors. The system will provide a simple a fast methodology for lawyers to re-number the list of jurors. (See FIG. 10) This tool is useful when jurors do not show up, or the juror list is reshuffled by the court. Records can be re-numbered without losing the name and other background records and notes that have been accumulated for each juror.

The system also provides for a method for including lawyers or user comments—to make notes about each juror. On the overview page for each juror, lawyers can instantly add notes to each juror's record. (See FIG. 7) These notes may contain any summary information that the lawyer, paralegals or jury consultants wish to record. This could be responses to questions. Notes about the juror's mood or disposition. Opinions from jury consultants, or others assisting in the case. The system allows the user to jump between jurors by simply entering the juror number and pressing enter. This allows the computer operator to jump quickly from juror to juror in order to enter questions. Using AJAX type functionality, it is easy for the lawyer to add notes without having to click the save button or reload the Web page.

The system also provides for a method to include juror questions with a system for lawyers to create questions to ask of jurors during voir dire. On the overview page for each juror, lawyers can add questions they wish to ask the juror during voir dire. (See FIG. 7) Juror Questions can be exported into a separate report for the lawyer conducting voir dire making it easy for the lawyer to ask focused questions during voir dire. The lawyer's trial consultants, paralegals or remote consultants can review the jurors information and submit questions instantly using this tool.

A print function provides a simple way to print a list of juror names with questions to in large type. The lawyer conducting voir dire can easily refer to the questions which are being drafted by one or more colleagues. The system allows for fast jumping between jurors by simply entering the juror number and pressing enter. This allows the computer operator to jump quickly from juror to juror in order to enter questions. Using AJAX type functionality, the lawyer may add questions without having to click the save button or reload the Web page after each entry.

The system also provides for juror status toggles with a system for lawyers to define the status or each juror during voir dire. Various toggles have been defined to indicate the status of each juror. (See FIG. 7) A rating tool allows the lawyer to drag and drop a rating scale from 1 to 10 for each juror. There are status toggle flags for peremptory challenge, cause challenge, hardship, selected as juror and juror Dismissed. When a juror is Dismissed, the jurors on-screen record is minimized and condensed to a single line on the screen. All other users in multiple locations are notified so that the dismissed juror no longer appears as a juror who should be analyzed. Jurors who are toggled as “Dismissed” are hidden or minimized in the juror's record from the list of prospective jurors.

Another embodiment of the invention is the reporting features that provides a system of exporting data from the jury research system. Detailed juror cards can be printed on large index cards. The cards contains all summary data. (See FIG. 13) Data can be exported and customized by the lawyer. For example, if a custom formatted juror card is needed, or a special report or other item is needed, exporting to Excel or other tabular format allows customization by the user. Exporting data to Excel also allows the lawyer to edit and study the data offline. In addition, exporting the data to Excel allows the lawyer to customize reports and integrate data from other systems. Detailed Reports can be downloaded for offline review for each juror. Custom reports can be written for each case.

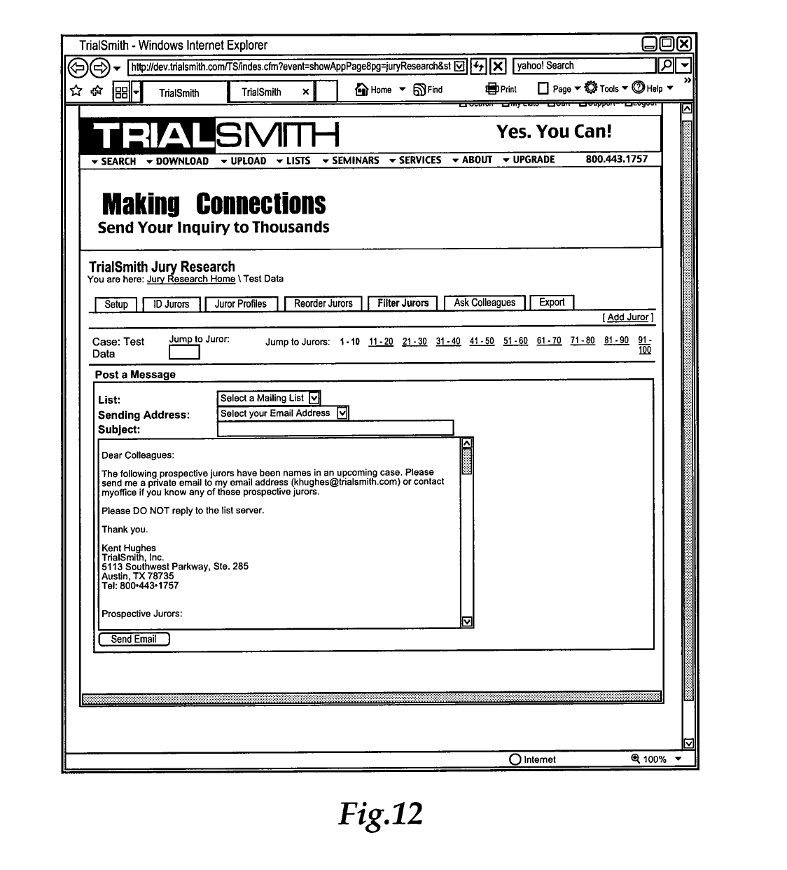

Another embodiment of the invention is the connectivity with the lawyer's or user's professional network of lawyers and colleagues. This tool allows the lawyer to instantly communicate with other trial lawyers about the juror list. With a single click the lawyer can “Ask Colleagues” about the jury list. (See FIG. 12) The tool automatically creates an email with a concise alphabetically listing of jurors. The list of jurors can be edited with the lawyer's own personal note. The lawyer would typically ask lawyers if they know any of the jurors or have any useful information.

The lawyer can then select one or more list servers to send the juror list. Or the lawyer may target the communication to lawyers residing in the trial's jurisdictional area where lawyers are most likely to know of the jurors. Lawyers within the inquiring lawyers' network are instantly presented via email a complete list of jurors. This step allows drafting of a communication containing juror names and instant email delivery to lawyers in just seconds. The system supports instantly chatting between lawyers, paralegals and jury consultants during a trial. The system not only stores and tracks information on each juror, but it provides a chat system within the platform.

The chat tool allows all lawyers, paralegals and trial consultants within the jury system to instantly send messages to each other, without having to leave the jury system. Messages may include warnings, special questions, notes about findings, or other information that can be instantly exchanged. The messages of the chat tool are instantly viewed on all screens and all Web browser of users working on the case in real time. Messages within the chat tool are permanently stored and can be scrolled for later analysis by the lawyers. However, individual messages within the chat tool may be deleted, if desired by the user.

An additional embodiment is a system for analyzing juror behaviors, physical attributes and body language to determine traits of the juror. The lawyer, paralegal or trial consultants may use the tool to record behaviors and physical clues about each juror during voir dire. The factors and traits identified for each juror can be recorded by a person who is not necessarily skilled in the art of analyzing body language because the factors and traits are easily recognizable. An independent lawyer or paralegal simply records the traits during voir dire.

The jury research system, utilizing known research and the body of knowledge on body language and physical attributes, automatically develops a profile on various factors about the juror including their attentiveness, their interest in the case, their attitudes and other factors that have been proven through scientific research. A jury research system that is flexible to integrate other jury research tools with an application programming interface. The system is designed with an API that allows for other jury research systems, methodologies, applications and databases to be integrated. The Web-based system allows access to these integrated services without the installation of additional software by end-users.

A jury research system that is software as a service. While the jury research system is software, the jury research system is a Web-based solution that requires no installation. The invention can be licensed by lawyers and instantly activated online through a Web interface without costly setup fees. The lawyer can instantly define a case, the number of prospective jurors and begin research. No setup, configuration or activation is required by staff members.

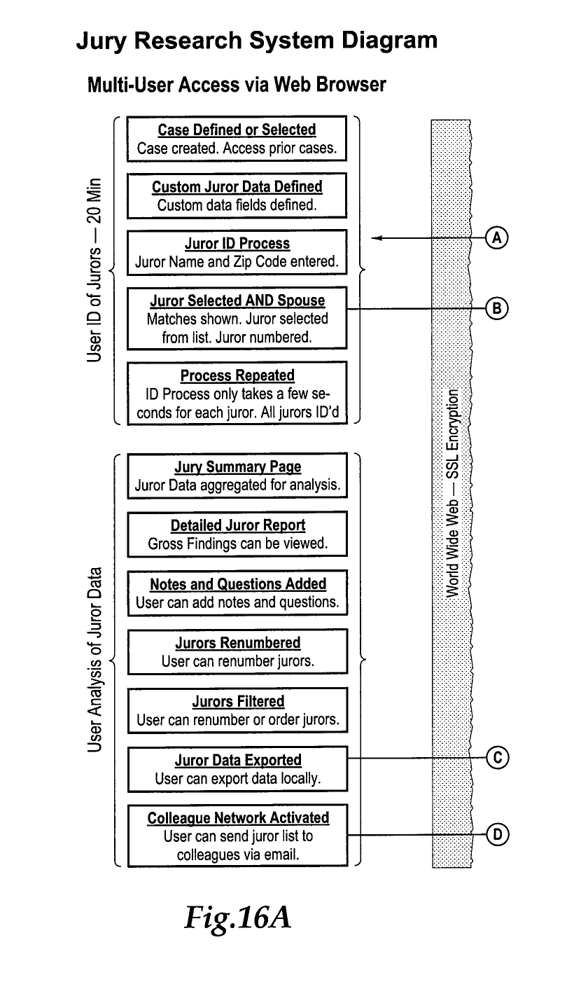

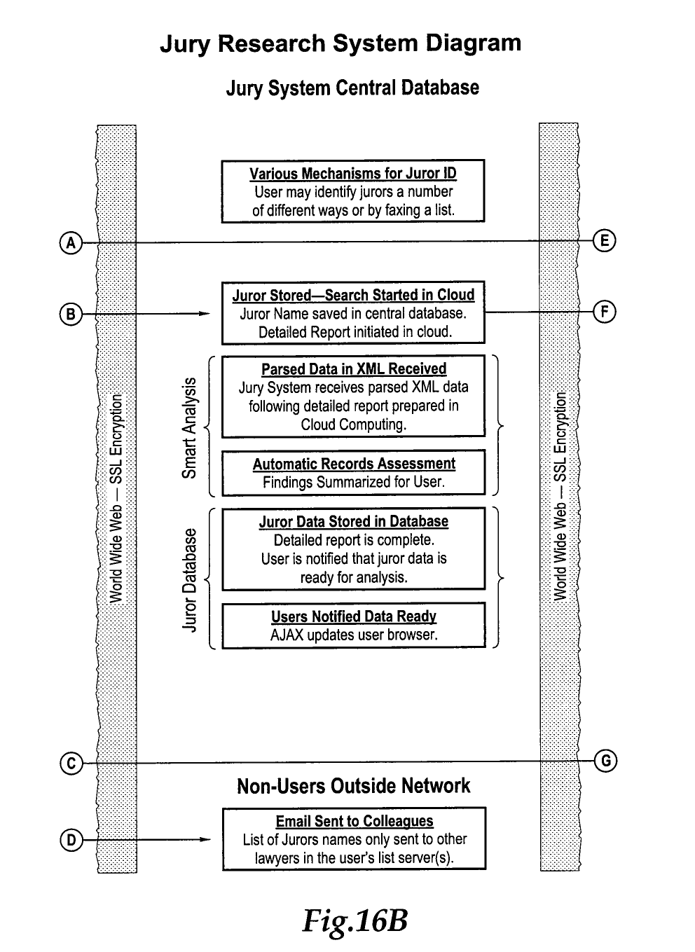

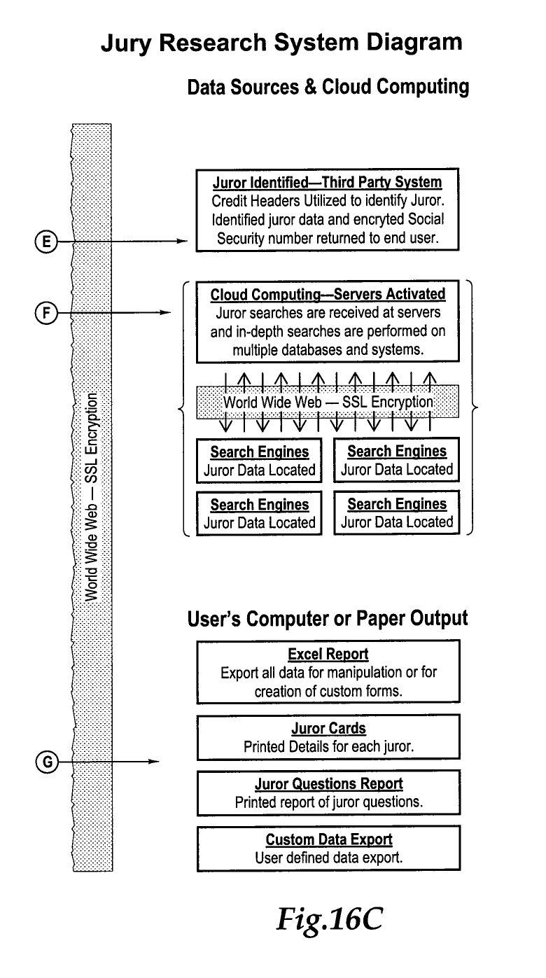

FIG. 16 is a schematic of the tools, system and functionality of the features of the invention described above.

While the invention has been described with a limited number of embodiments, these specific embodiments are not intended to limit the scope of the invention as otherwise described and claimed herein.

1. A system for analyzing data on individuals comprising the steps of
inputting the name of at least one individual in a query to the internet through a web browser from at least one device;
accessing data from at least one designated location in the internet;
matching the name inputted to data on individuals in the designated locations;
transmitting the matches from at least one inputted name to at least one device such that a user can select a match from the list;
simultaneously with the transmitting step, searching the internet locations with multiple computers via cloud computing for data on at least one individual;
parsing the data found on at least one location on the internet on at least one individual;
preparing a detailed report on the data that is accessible to at least one user via the internet; and
sending the report to at least one recipient over the internet.

2. A system of claim 1 additionally comprising the step of forwarding the name of at least one individual to a list on at least one list server for review by the recipients.

3. A system of claim 1 wherein the detailed report can be edited by the recipient.

4. A system of claim 1 wherein databases not located on the internet can be accessed to include information in the detailed report.

5. A system of claim 1 wherein questions and notes can be added by a user for at least one individual in the detailed report.
